(19) United States
(12) Patent Application Publication
(10) Pub. No.: US 2013/0293509 A1
(43) Pub. Date: Nov. 7, 2013

(54) ELECTRONIC DEVICE WITH TOUCH SENSITIVITY

(71) Applicant: SENTELIC CORPORATION, Taipei City (TW)

(72) Inventor: Wen-Ting Lee, Taipei City (TW)

(73) Assignee: SENTELIC CORPORATION, Taipei City (TW)

(21) Appl. No.: 13/787,847

(22) Filed: Mar. 7, 2013

(30) Foreign Application Priority Data
May 3, 2012 (TW) 101115778

(51) Int. Cl. G06F 3/044

(52) U.S. Cl. CPC G06F 3/044
USPC 345/174

(57) ABSTRACT

An electronic device includes a touch panel and a control module. On the display panel, m columns of sensing capacitors are disposed along a first direction and n rows of sensing capacitors are disposed along a second direction. The control module includes M column output channels, N row output channels, M column scan lines and N row scan lines. Each column scan line includes a first end coupled to a corresponding column output channel and a second end spreading into A sub scan lines which are coupled to A adjacent columns of sensing capacitors among the m columns of sensing capacitors, respectively. Each row scan line includes a first end coupled to a corresponding row output channel and a second end spreading into B sub scan lines which are coupled to B adjacent rows of sensing capacitors among the n rows of sensing capacitors, respectively.

### BACKGROUND OF THE INVENTION

1. Field of the Invention

The present invention is related to a touch-sensitive electronic, and more particularly, to a touch-sensitive electronic device which improves positioning accuracy by spreading scan lines.

2. Description of the Prior Art

Among various consumer electronic devices, tablet computer, personal digital assistant (PDA), mobile phone, global positioning system (GPS) and media player normally adopt touch panels as the user interface due to limited space and intuitive user experience. Common touch technologies include resistive, capacitive and optical types. Capacitive touch panels are widely used in high-end consumer products due to high sensing accuracy, multi-touch ability, high durability and high resolution. Using capacitive touch technology, the time and location of a touch event may be determined by detecting capacitance variations caused by static electricity when an object comes in contact of the touch panel.

FIG. 1 and FIG. 2 are diagrams illustrating a prior art electronic device 100. The electronic device 100 includes a capacitive touch panel 10 and a control module 20. The capacitive touch panel 10 includes a sensing array having a plurality of sensing capacitors. More specifically, M columns of sensing capacitors (represented by white diamonds in FIG. 1 and FIG. 2) are disposed on the capacitive touch panel 10 along the vertical direction, and N rows of sensing capacitors (represented by dotted diamonds in FIG. 1 and FIG. 2) are disposed on the capacitive touch panel 10 along the horizontal direction. The control module 20, having M column output channels and N row output channels, is configured to transmit signals to corresponding sensing capacitors via a plurality of scan lines. The 1^{st} to M^{th} column scan lines X₁˜X_{M} are coupled to corresponding 1^{st} to M^{th} columns of sensing capacitors, respectively. The 1^{st} to N^{th} row scan lines Y₁˜Y_{N} are coupled to corresponding 1^{st} to N^{th} rows of sensing capacitors, respectively. The contact coordinates of the capacitive touch panel 10 may be defined by the scan lines. For example, the intersection of the 3^{rd} column scan line X₃ and the 3^{rd} row scan line Y₃ corresponds to the contact coordinate (X₃, Y₃).

Assume that the capacitance of each sensing capacitor is C. Without receiving any touch command, the capacitance of each column of sensing capacitors is N*C, and the capacitance of each row of sensing capacitors is M*C. If a touch command is issued at the intersection of the 3^{rd} column scan line X₃ and the 3^{rd} row scan line Y₃, the capacitance of the 3^{rd} columns of sensing capacitors detected by the control module 20 is (N*C+ΔC1), and the capacitance of the 3^{rd} row of sensing capacitors detected by the control module 20 is (N*C+ΔC2). The contact coordinate (X₃, Y₃) may thus be determined.

FIG. 1 illustrates an embodiment when the electronic device 100 receives touch commands from a human finger. When a touch command is issued at the intersection of the 3^{rd} column scan line X₃ and the 3^{rd} row scan line Y₃, the finger with a larger contact surface may be in contact with at least one sensing capacitor among the 3^{rd} column of sensing capacitors and at least one sensing capacitor among the 3^{rd} row of sensing capacitors. Therefore, the control module 20 may detect capacitance variations in the horizontal and vertical directions simultaneously, thereby acquiring the corresponding contact coordinate.

FIG. 2 illustrates an embodiment when the electronic device 100 receives touch commands from a stylus. When a touch command is issued at the intersection of the 3^{rd} column scan line X₃ and the 3^{rd} row scan line Y₃, the stylus with a smaller contact surface may only be in contact with one sensing capacitor, which may either be one among the 3^{rd} column of sensing capacitors or one among the 3^{rd} row of sensing capacitors. Therefore, the control module 20 may only detect capacitance variations in either the horizontal direction or the vertical direction, thereby failing to determine the accurate contact coordinate.

Without increasing the number of scan line in the control module 20, the prior art electronic device 10 may not be able to identify touch commands accurately when the input object has a small contact surface (such as a stylus or a small finger). There is a need to improve the positioning accuracy of a touch-sensitive electronic.

### SUMMARY OF THE INVENTION

The present invention provides a touch-sensitive electronic having a touch panel and a control module. On the touch panel, columns of sensing capacitors are disposed along a first direction and n rows of sensing capacitors are disposed along a second direction perpendicular to the first direction. The control module includes M column output channels, N row output channels, M column scan lines and N row scan lines. Each of the M column scan lines includes a first end coupled to a corresponding column output channel among the M column output channels and a second end spreading into A sub scan lines which are coupled to A adjacent columns of sensing capacitors among the m columns of sensing capacitors, respectively. Each of the N row scan lines includes a first end coupled to a corresponding row output channel among the N row output channels and a second end spreading into B sub scan lines which are coupled to B adjacent rows of sensing capacitors among the n rows of sensing capacitors, respectively. A, B, M, N, m and n are positive integers, A*M=m and B*N=n.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 and FIG. 2 are diagrams illustrating a prior art electronic device.

FIG. 3 and FIG. 4 are diagrams illustrating an electronic device according to the present invention.

FIGS. 5-8 are diagrams illustrating the scan line spreading according embodiments of the present invention.

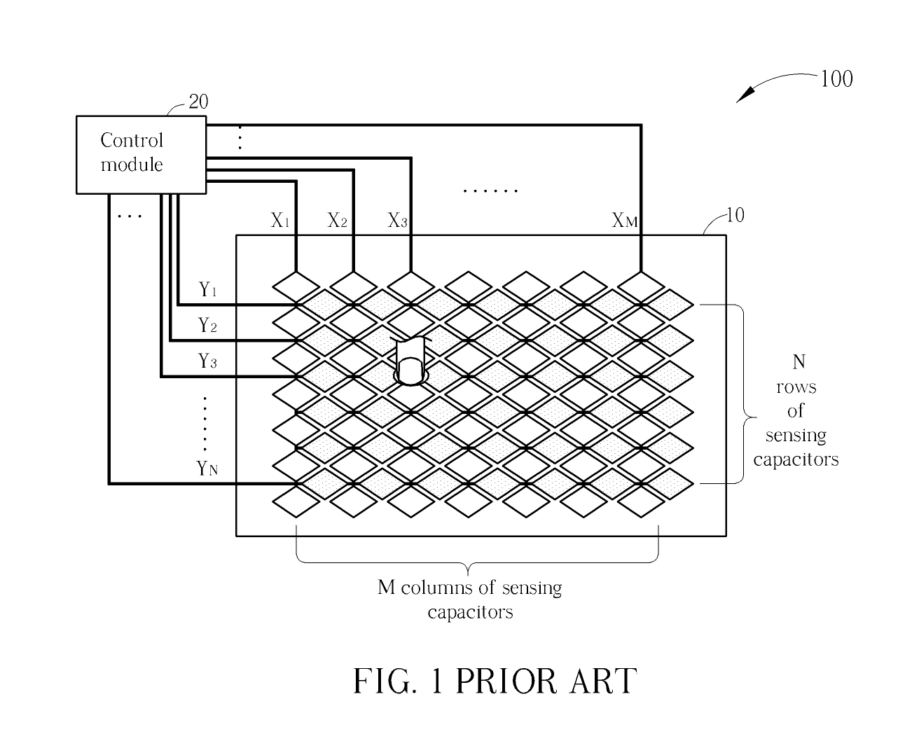

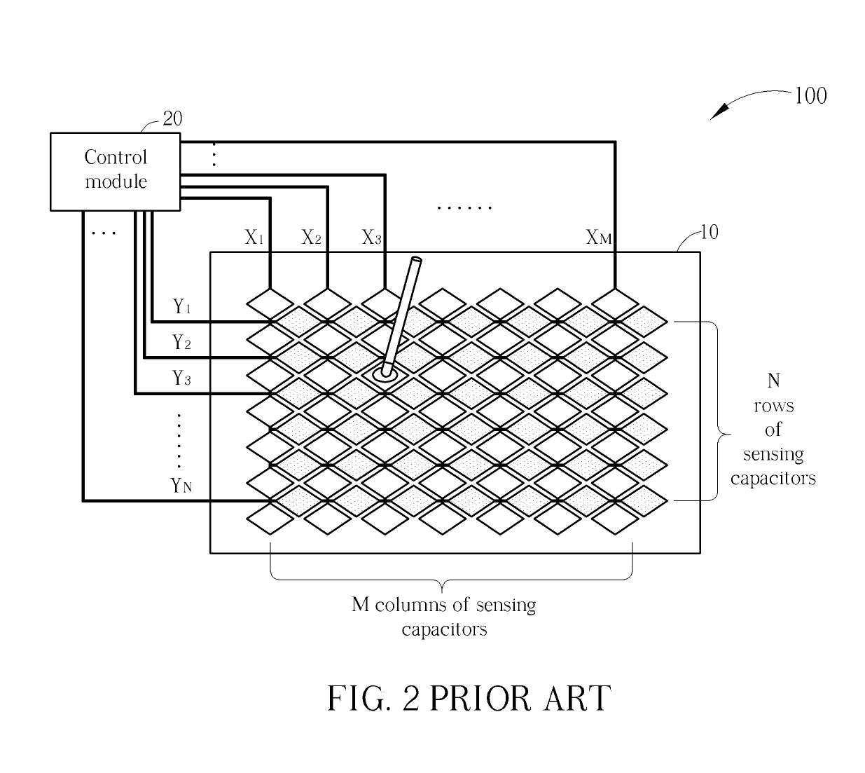

### DETAILED DESCRIPTION

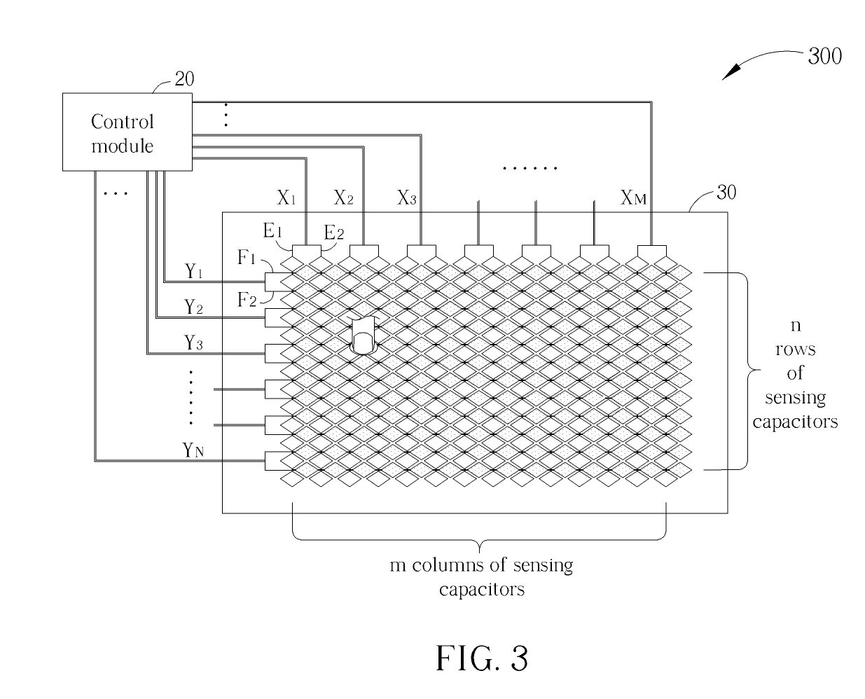

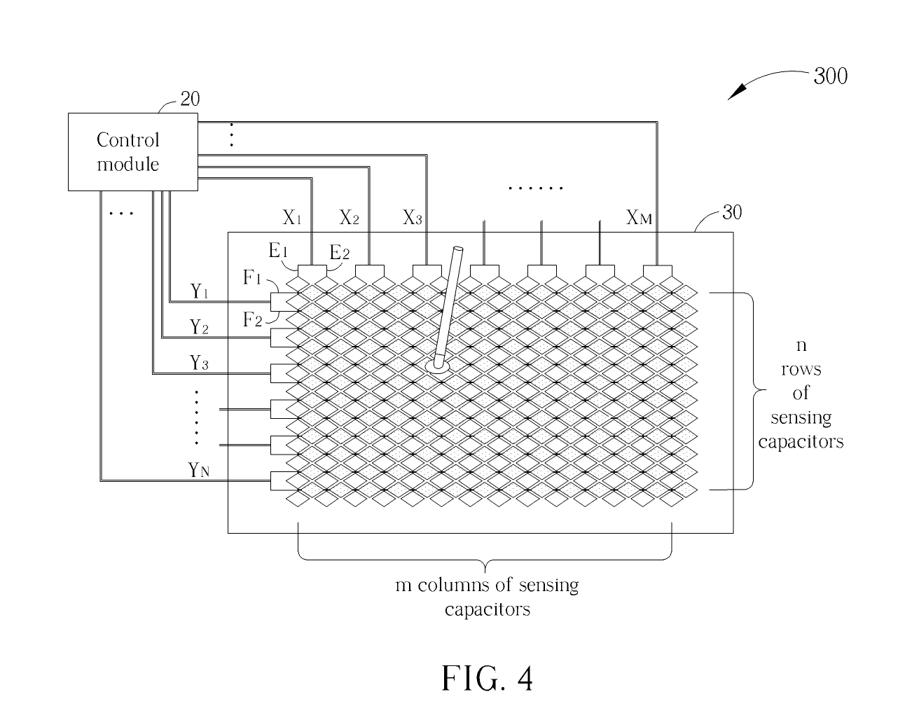

FIG. 3 and FIG. 4 are diagrams illustrating an electronic device 300 according to the present invention. The electronic device 300 includes a capacitive touch panel 30 and a control module 20. The capacitive touch panel 30 includes a sensing array having a plurality of sensing capacitors. More specifically, m columns of sensing capacitors (represented by white diamonds in FIG. 3 and FIG. 4) are disposed on the capacitive touch panel 30 along the vertical direction, and n rows of sensing capacitors (represented by dotted diamonds in FIG. 3 and FIG. 4) are disposed on the capacitive touch panel 30 along the horizontal direction.

The control module 20, having M column output channels and N row output channels, is configured to transmit signals to corresponding sensing capacitors via a plurality of scan lines. For example, each of the 1^{st} to m^{th} column scan lines X₁˜X_{M} includes a first end coupled to a corresponding column output channel of the control module 20 and a second end spreading into A sub scan lines E₁-E_{A} which are coupled to A adjacent columns of sensing capacitors, respectively. Each of the 1^{st} to N^{th} row scan lines Y₁-Y_{N} includes a first end coupled to a corresponding row output channel of the control module 20 and a second end spreading into B sub scan lines F₁˜F_{B} which are coupled to B adjacent rows of sensing capacitors, respectively. FIGS. 3 and 4 illustrate embodiments when A=2 and B=2, which do not limit the scope of the present invention. A and B may be identical or different integers larger than 1 as long as “A*M=m” and “B*N=n” are satisfied. The contact coordinates of the capacitive touch panel 30 may be defined by the scan lines. For example, the intersection of the 3^{rd} column scan line and the 3^{rd} row scan line corresponds to the contact coordinate (X₃, Y₃).

FIG. 3 illustrates an embodiment when the electronic device 300 receives touch commands from a human finger. When a touch command is issued at the intersection of the 3^{rd} column scan line X₃ and the 3^{rd} row scan line Y₃, the finger with a larger contact surface may be in contact with at least one sensing capacitor among the 3^{rd} column of sensing capacitors and at least one sensing capacitor among the 3^{rd} row of sensing capacitors. Therefore, the control module 20 may detect capacitance variations in the horizontal and vertical directions simultaneously, thereby acquiring the corresponding contact coordinate.

FIG. 4 illustrates an embodiment when the electronic device 300 receives touch commands from a stylus. When a touch command is issued at the intersection of the 3^{rd} column scan line X₃ and the 3^{rd} row scan line Y₃, the stylus with a smaller contact surface may also be in contact with at least one sensing capacitor among the 3^{rd} column of sensing capacitors and at least one sensing capacitor among the 3^{rd} row of sensing capacitors. Therefore, the control module 20 may also detect capacitance variations in the horizontal and vertical directions simultaneously, thereby acquiring the corresponding contact coordinate.

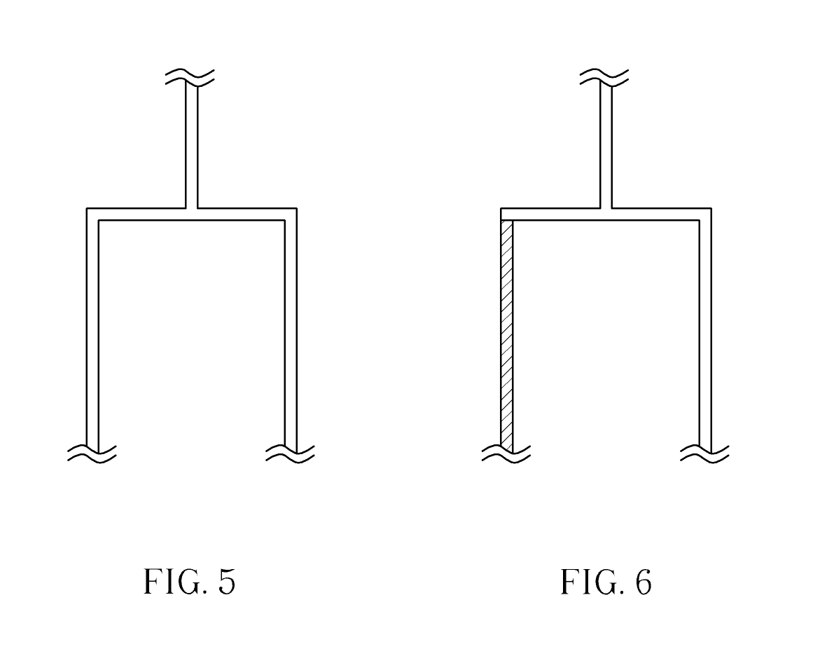

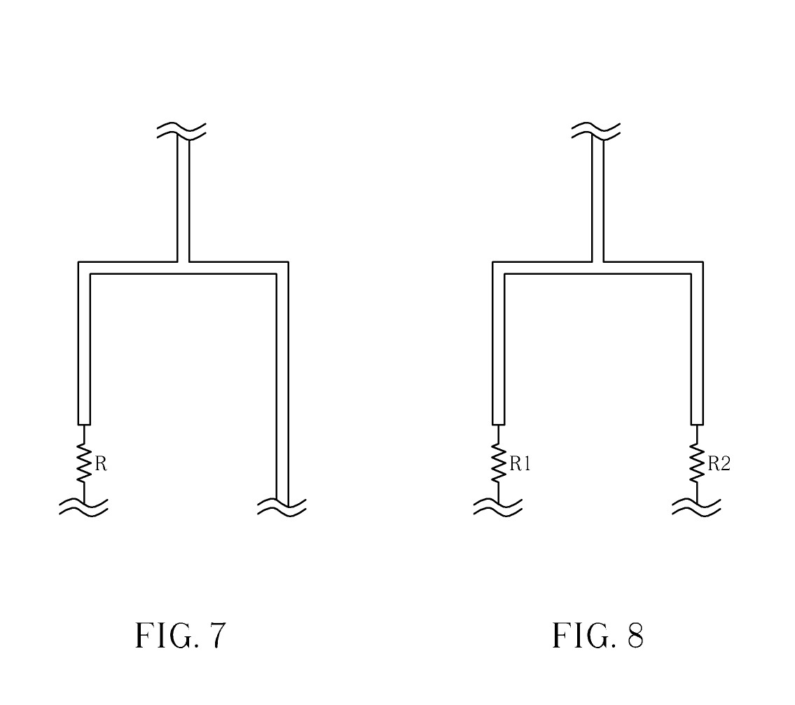

FIGS. 5-8 are diagrams illustrating the scan line spreading according embodiments of the present invention. For illustrative purpose, assume that each scan line spreads into two sub scan lines. In the embodiment illustrated in FIG. 5, each scan line may spread into two sub scan lines having the same impedance for providing two transmission paths having the same equivalent impedance. In the embodiment illustrated in FIG. 6, the two sub scan lines may be made of different materials for providing two transmission paths having different equivalent impedances. In the embodiment illustrated in FIG. 7, one of the two sub scan lines may be coupled to a resistor R for providing two transmission paths having different equivalent impedances. In the embodiment illustrated in FIG. 8, the two sub scan lines may be respectively coupled to resistors R1 and R2 for providing two transmission paths having different equivalent impedances.

In the present invention, the sub scan lines E₁˜E_{A} and the sub scan lines F₁˜F_{B} may have identical or different equivalent impedances. In FIG. 4 as an example, if the sub scan lines E₁˜E₂ and the sub scan lines F₁˜F₂ have different equivalent impedances, the control module 30 may further detect the capacitance variations in the sensing capacitors of a specific sub scan line, thereby acquiring the corresponding contact coordinate more accurately.

In the embodiment of the present invention, the capacitive touch panel 30 may be an out-cell touch panel or an in-cell/on-cell touch panel. An out-cell touch panel is provided by assembling a standalone touch panel with a standard display panel, while an in-cell/on-cell touch panel is provided by forming touch sensitive devices directly on the substrate of a display panel.

In the embodiment of the present invention, the capacitive touch panel 30 may adopt self capacitance measurement technique in which each sensing capacitor of the capacitive touch panel 30 is independently coupled to ground. The control module 20 may scan each independently grounded sensing capacitor and measure its ground current. When a touch event occurs, the current induced by coupling effect may be directed to ground via another path provided by human finger or stylus. Based on the increase in the ground current, the control module 20 may calculate the location of the contact point.

In the embodiment of the present invention, the capacitive touch panel 30 may adopt mutual capacitance measurement technique in which the control module 20 is configured to input electrical signals to each sensing capacitor of the capacitive touch panel 30 for establishing sensing regions at the intersections of the sensing capacitors. The capacitance of each sensing region is locally related to adjacent sensing capacitors and may vary when receiving a touch command. Based on the capacitance variation, the control module 20 may calculate the location of the contact point.

Without increasing the number of the scan lines in the control module 20, the electronic device 30 of the present invention may increase the accuracy of identifying touch command regardless of the size of the input device by spreading the scan lines.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch-sensitive electronic, comprising:
a touch panel on which m columns of sensing capacitors are disposed along a first direction and n rows of sensing capacitors are disposed along a second direction perpendicular to the first direction; and
a control module, comprising:
M column output channels;
N row output channels;
M column scan lines each comprising:
a first end coupled to a corresponding column output channel among the M column output channels; and
a second end spreading into A sub scan lines which are coupled to A adjacent columns of sensing capacitors among the m columns of sensing capacitors, respectively; and
N row scan lines each comprising:
a first end coupled to a corresponding row output channel among the N row output channels; and
a second end spreading into B sub scan lines which are coupled to B adjacent rows of sensing capacitors among the n rows of sensing capacitors, respectively;
wherein A, B, M, N, m and n are positive integers, A*M=m and B*N=n.

2. The electronic device of claim 1, wherein each column scan line provides A transmission paths having different equivalent impedances between the corresponding column output channel and the A adjacent columns of sensing capacitors.

3. The electronic device of claim 2, wherein the A sub scan lines of each column scan line includes different materials.

4. The electronic device of claim 2, further comprising a resistor coupled between a sub scan line and a corresponding column of sensing capacitor.

5. The electronic device of claim 2, further comprising a plurality of resistors having different equivalent impedances, wherein each resistor is coupled between a sub scan line and a corresponding column of sensing capacitors.

6. The electronic device of claim 1, wherein each row scan line provides B transmission paths having different equivalent impedances between the corresponding row output channel and the B adjacent rows of sensing capacitors.

7. The electronic device of claim 6, wherein the B sub scan lines of each row scan line includes different materials.

8. The electronic device of claim 6, further comprising a resistor coupled between a sub scan line and a corresponding row of sensing capacitors.

9. The electronic device of claim 6, further comprising a plurality of resistors having different equivalent impedances, wherein each resistor is coupled between a sub scan line and a corresponding row of sensing capacitors.
